(19) United States
(12) Patent Application Publication
(10) Pub. No.: US 2011/0208328 A1
(43) Pub. Date: Aug. 25, 2011

(54) STRATIFICATION-BASED AND CATEGORIZATION-BASED SYSTEM AND METHOD FOR HARNESSING COLLECTIVE INTELLIGENCE TO PREDICT SPORTS OUTCOMES

(76) Inventors: Christopher Scott Cairns, Arlington, VA (US); Sean Allen Johnson, Chapel Hill, NV (US)

(21) Appl. No.: 13/031,781

(22) Filed: Feb. 22, 2011

Related U.S. Application Data
(60) Provisional application No. 61/338,524, filed on Feb. 22, 2010.

(51) Int. Cl. G06F 19/00

(52) U.S. Cl. 700/93

(57) ABSTRACT

A system and method for stratifying and categorizing individuals based on their ability to predict the outcome of sporting events and crowd sourcing the individual's sporting event predictions according to the system and method to generate improved prediction regarding specific sporting events.

### TERMINOLOGY

User—A person whose predictions are being measured by the method or device.

Community of users—The total collection of all the users wherein, increasing the community of users will likely result in the method generating more accurate predictions.

Distinguished User—A user who has achieved a predetermined success rate benchmark in a (Specific Prediction Combination Type) is marked a distinguished user. A user can be marked a distinguished user for zero, one, or multiple (Specific Prediction Combination Types). (Future Outcomes) are predicted by the method when distinguished users are in sufficient agreement as to what the outcome of a particular (Specific Prediction Combination Type) will be. A distinguished user always makes a distinguished prediction, and a distinguished prediction is always made by a distinguished user.
Note: A user's Future Outcome predictions in a (Specific Prediction Combination Type) of which the user is not a distinguished user will not be considered when determining a (Future Outcome) to a (Specific Prediction Combination Type), because by definition that user is not a distinguished user for that (Specific Prediction Combination Type) and will not be marked by the method as such.

Specific Prediction Combination Type—The specific (Type of Prediction), (Type of Sporting Event), and (Participants of a Sporting Event) combination of any event.

Historical Outcomes—The result of a (Specific Prediction Combination Type), wherein the result of a user's prediction can generate multiple (Categorized Inputs) for the first data set.

For example: The result of a moneyline bet on the favored New Orleans Saints to win against the Atlanta Falcons would generate inputs in the first data set regarding that user's performance in events that include the New Orleans Saints, the Atlanta Falcons, the NFC South Division (the division of which both these teams are a member), the NFC (the conference of which both these teams are a member), NFL (the league of which both these teams are a member), Football, and the user's overall correct-to-incorrect predictions ratio. Any of these variables may be optionally eliminated, or discounted.

Categorized Input—An input in either data set that represents a single (Specific Prediction Combination Type).
Note: Not all three variables of a (specific prediction combination type) are necessary to generate a categorized input. 0, 1, 2, or all 3 variables present will generate a categorized input. When 0 variables are present only 1 categorized input is recorded, naming that of the users over all record of success. When more than 0 variables are present categorized inputs are created for every combination of those variables, for each variable as if it existed independently, and as if there were 0 variables.

Data Set—Data Set containing all (Historical Outcomes) of the (Community of Users) wherein the (Categorized Inputs) are associated with the specific user who generated said (Categorized Inputs).

Future Outcomes—The prediction of a specific future result comprising a (Type of Prediction) and (Participants of a Sporting Event) combination, wherein the (Participants of a Sporting Event) is limited to only the specific teams or players competing.
Note: Future outcomes are predictions but are not to be confused with Future's Predictions which are a specific Type of Prediction. Once a particular sporting event has concluded the results of any particular user's Future outcomes become historical outcomes and are recorded in the data set along with additional Categorized Input the event may have generated Only Distinguished User's Future Outcomes are used to make predictions by the method.

Type of Prediction—The specific type of outcome predicted, optionally including but is not limited to: Moneyline Prediction, Spread Prediction, Over-Under Prediction, Future's Prediction.

Type of Sporting Event—The specific sport on which a prediction is being made, optionally including but not limited to Professional, College, and Amateur: Football, Baseball, Basketball, Hockey, Soccer, Tennis, Golf, Olympic Events, Boxing, Bowling, Darts, Rugby, Cricket, and Mixed Martial Arts.

Participants of a Sporting Event—Includes the players or teams competing in the event, each or the divisions, conferences, leagues, or confederations they are members of, or simply the sporting event type.

Moneyline Prediction—a prediction of the winner of the sports game, with more points awarded for picking the unfavored team and less points for picking the favored team.

Spread Prediction—a prediction of the winner of a sports game, against an expected point differential based on the strengths of the two teams.

Over-Under Prediction—a prediction that the combined total score of the two teams in a sporting event will be more or less than a given total score.

Future's Prediction—any other prediction about the happenings during a sporting event not tied to the final score of the event. This includes data relating to a specific individuals performance in a sporting event, including but not limited to: number of touchdowns thrown, number of yards rushed for, number of strikeouts, number of rebounds, number of goals scored, number of assist made or number of fantasy points made.

Consensus—may optionally be determined by plurality, majority, or supermajority.

### BRIEF DESCRIPTION OF THE DRAWINGS

FIG. 1 shows a User Prediction being processed by a computer yielding a system prediction.

FIG. 2 shows the stratification process that occurs with every User Prediction with various types of Specific Prediction Combination Types shown.

FIG. 3 shows the system prediction process.

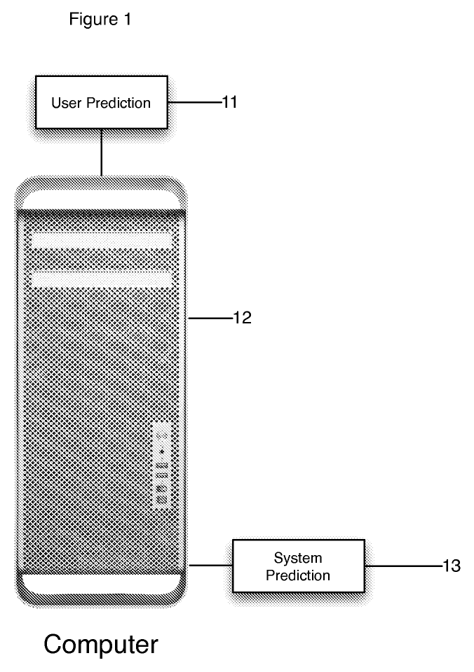

FIG. 1 illustrates a user prediction (11) being processed by a computer (12) using the method of this application and yielding a system prediction (13).

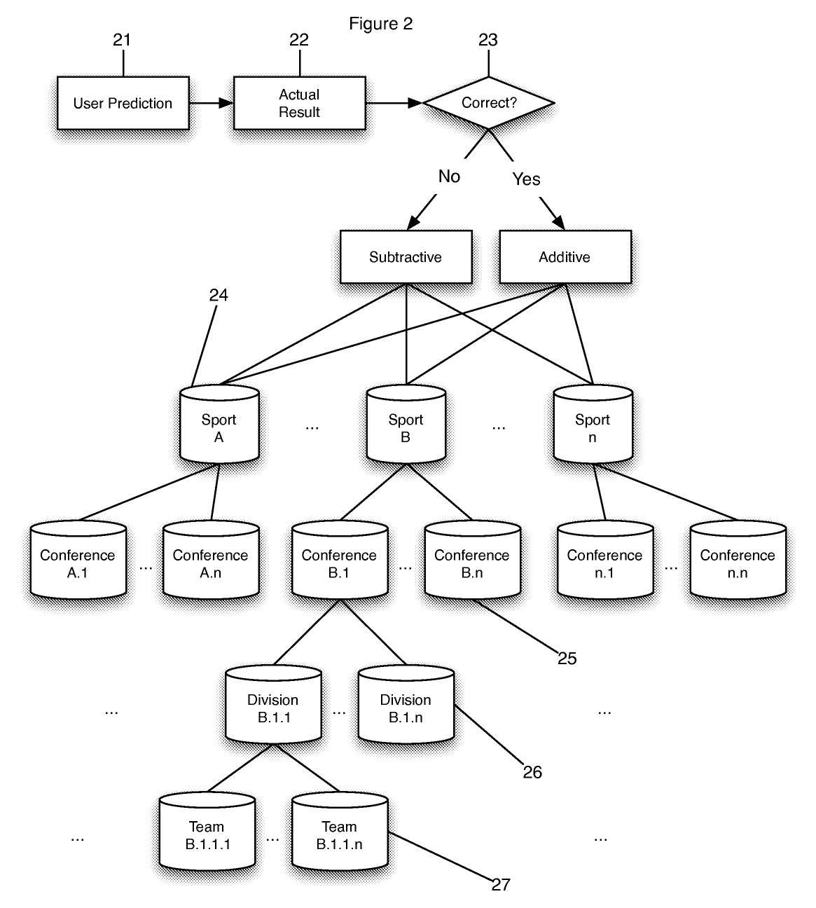

FIG. 2 illustrates the stratification and categorization process. When a final result to a sporting event occurs (22) the user prediction (21) for that sporting event is determined to be correct or incorrect (23) which affects the user's records in any category that encompasses that specific sporting event. Sports A, B, N (collectively 24) are the most exclusive categories and correspond to for example the NFL or NBA. Conferences A.1, A.n, B.1, B.n, C.1, C.n, n.1, n.n (Collectively 25) is the next layer of specification and corresponds to for example the NFC or the Western Conference. Division B.1.1, B.1.n (collectively 26) show a further division of the Conference level and corresponds to for example the North or East division. Finally Team B.1.1.1, B.1.1.n (collectively 27) is the final layer of partitioning and corresponds to particular teams or individual entities in a sporting event for example the New Orleans Saints or the Los Angles Lakers.

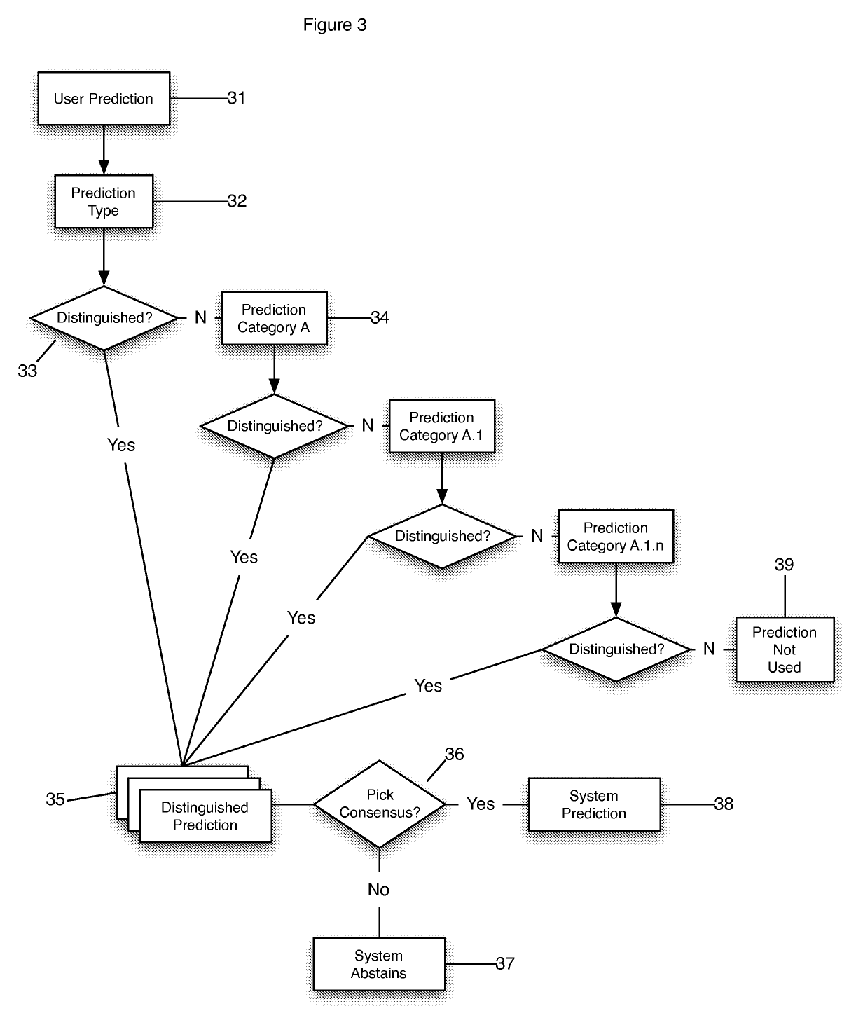

The prediction type (32) in FIG. 3 refers to the stratification and categorization that is shown in FIG. 2.

FIG. 3 illustrates the system prediction process. A user prediction (31) for example the Saints will beat the Colts is analyzed by prediction type (32) and for each category A, A.1, A.1.n (collectively 33) a decision is made as to whether the user has been identified (flagged) as a distinguished user. If the user prediction is generated by a user who is not a distinguished user for any of the categories that encompass the sporting event then the prediction is not used (39). The system collects all the distinguished users (35) who have entered a user prediction on the sporting event and determines if there is a pick consensus (36) the system generates a system prediction (38) that the event will occur for example that the Saints will beat the Colts. If there is no pick consensus (36) the system abstains (37) from generating a system prediction (38).

There is a world-wide marketplace for various types of outcome predictions for future sporting events. The present invention provides a method and apparatus for predicting the outcome with greater accuracy.

The method and system is designed to provide predictions for various outcomes of future sporting events i.e. system predictions (13), (27), (37). It does this by measuring each user's historic outcomes against the overall community of user's historic outcomes, stratifying the individuals into a categories and flagging those that are distinguished, those with statistically significant predictive ability for a particular type of prediction for a particular category of sporting event (shown in FIG. 2 and referred to in (32)). Then the system generates a prediction (38) whenever consensuses (36) of identified distinguished users (35) make the same prediction for a future sporting event.

This is accomplished by:
1. Collecting historical outcomes from the community of users and optionally weighting each prediction based on how many points are at risk.
2. Segmenting said historical outcomes by specific prediction combination type (shown in FIG. 2 and referred to in (32)) to identify any instances of above average prediction performance for each user.
3. Stratifying users based on their said historical outcomes to identify and mark distinguished users for particular specific prediction combination types (shown in FIG. 2 and referred to in (32)).

Users can chose from all possible sporting events and predict only the outcomes for which they have reason to believe they will predict correctly. With each outcome the user is optionally allowed to risk a variable number of points, the more points the put at risk or wagered on the event, the more they gain if they are correct. These points can be optionally used to indicate how confident the user is in their prediction, and can optionally be factored into how distinguished users are determined as discussed below.

When viewed overall, the differential between individual's historic outcomes tends to be fairly marginal. To improve the predictive ability, the method doesn't just measure historic performance overall, but measures it against a hierarchy of categories that describe each sporting event. Once these categories are taken into account the differences in historic performance between individuals becomes much more pronounced.

A hierarchy is formed as such:
Sport→League→Conference→Division→Team (shown in FIG. 2 and referred to in (32))

Another orthogonal aspect is layered across this hierarchy, namely the type of outcome that's being predicted (Type of Prediction), be it the winner of the game with a higher reward for selecting the team that is unfavored to win (a “moneyline” prediction), the winner of the game against a projected point differential (a “spread” prediction), the total combined points of both teams (an “over-under” prediction) or various miscellaneous other outcomes (“future's” prediction) such as the first team or player to score a point (Shown in FIG. 2 and referred to in (32)).

The result of this hierarchy and the prediction type yields a recording system for measuring the result of individual's past predictions, from the most generalized, such as any prediction of any football game, or an over-under prediction of any sporting event, to the most specific, such as a moneyline prediction of a football game involving the UNC Tarheels football team (shown in FIG. 2 and referred to in (32)).

The result of each prediction is measured in its correctness (23), be it correct, incorrect, or neither (a tie or “push”), and in how many points were won or lost on the prediction. Measuring the points won or lost is done so that both the user's confidence in the prediction and the relative safety or riskiness of the prediction is accounted for. A large number of points risked on a risky prediction will result in a very large point return, whereas a small number of points risked on a very safe prediction will result in a small point return. As a result, there is both a historic basis for how often an individual was right or wrong, and also a historic basis for the average number of points lost or gained by the user on this type of prediction. This data is recorded in each of categories shown in FIG. 2 (24), (25), (26), (27).

In one embodiment the average number of points won or lost per wager/bet is called the users BetIQ.

The result of combining each user's prediction (11), (21), (31) history against the actual sporting events outcome (23), across the hierarchy, and the various prediction types yields a quantitative measure of each individual for each point in the hierarchy and each type of prediction.

When a particular benchmark is reached the user becomes a distinguished user. Said benchmark, in the preferred embodiment, is optionally weighted according to the amount of points wagered on each outcome. In the preferred embodiment, when determining if a benchmark has been met, the average number of points won or lost per bet (BetIQ) is compared against the average number of points won or lost per bet by the community of users.

In the preferred embodiment the benchmark is being ranked in the top 1% of all users in the community of users, or performing better than 99% of the community of users. In the preferred embodiment a minimum number of bets must be placed in a specific category before said benchmark can be considered, this is optional in other embodiments. The minimum number of bets required to be placed to be considered for distinguished user status can be optionally more than 2. In the preferred embodiment it is 31 bets.

In another embodiment said benchmark could optionally be, achieving a better than a 40%-99% prediction success rate for any specific category, for example 50%, 55%, 60%, 65%, 70%, 75%, 80%, 85%, 90%, or 95%.

In another embodiment said benchmark could also optionally be, being ranked in the top 60%-0.000001% of all users in the community for any specific category, for example, the top 0.0001%, 0.001%, 0.01%, 1%. 2%, 3%, 4%, 5%, 10%, 15%, 20%, 25%, 30%, 35%, 40%, 45%, or 50%.

In another embodiment said benchmark could also optionally be, obtaining a minimum total number of points in a specific category.

In another embodiment said benchmark could also optionally be, obtaining a minimum total number of correct picks in a specific category.

In another embodiment said benchmark could also optionally discount specific categories and only factor in overall performance using any of the metric previously mentioned.

In the preferred embodiment points are referred to as “Chips,” but may optionally have other names in other embodiments. In the preferred embodiment a distinguished user is referred to as a Genius or Expert but may optionally have other names in other embodiments.

For example, after weeks of predicting sports outcomes, user John Doe has predicted the winner against a spread correctly 40 times and incorrectly 10 times for football teams in the National Football League's National Football Conference Southern Division yielding an average gain of 22.8 points per prediction. There are enough bets by John Doe in this category to be statistically significant and the historic performance of the predictions puts John Doe above a specific threshold (such as the top 1% of all users) when compared to all other users' predictions for this type and category, so John Doe is identified as a distinguished user (33) for this type and category of prediction (spread predictions in the NFL's NEC South Division) and his predictions (11), (21), (31) for future sporting events that match this category and prediction type are scrutinized by the system as distinguished user predictions (35) that can be used as input to form the method's/system's own predictions (38).

### The Predictive Process:

1. Identify predictions that are made by a marked distinguished user (33).
2. Where a sufficient number of distinguished user predictions (35) of the same type on the same sporting event form a consensus (36) of predictions for the same outcome, the method dictates that, that out come be selected (38).

By the previously described stratification process (shown in FIG. 2 and referred to in (32)), distinguished users have been identified and marked. The predictions made by those distinguished users (35) that are in their specific prediction combination type are considered for the methods prediction of future outcomes (38).

When a sufficient number of distinguished user predictions (35) have predicted the same outcome to the same specific prediction combination type (36), that outcome is predicted to be the result of the sporting event (38). This prediction is therefore based on the harnessed collective intelligence of the entire group of users, the vast majority of users forming the background data by which to identify the outlying expertise, and the predictions of the identified distinguished users (35) forming the predictions of the method/system when a sufficient consensus is present.

The required consensus (36) of distinguished users can be established when there is agreement by optionally a plurality, majority, or supermajority of said distinguished users regarding a particular outcome in their specific prediction combination type of expertise.

In the preferred embodiment the percentage of distinguished users (35) who must agree to reach a sufficient consensus (36) can be between 10%-100%. For example at least 10%, 20%, 25%, 30%, 40%, 45%, 50%, 55%, 60%, 65%, 70%, 75%, 80%, 90%, or 100%.

In the preferred embodiment a minimum total number of distinguished users (35) must make a prediction before a consensus (36) can be calculated. In the preferred embodiment, where an insufficient number of distinguished user predictions (35) are made, or where the distinguished user predictions (35) contradict each other to a sufficient degree, the system/method refrains from making any prediction at all (37).

A sufficient number of distinguished user predictions (35) can optionally be when more than 1% of the total distinguished users for the relevant specific prediction combination type have submitted a prediction for a particular event in that specific prediction combination type.

In another embodiment a minimum total number of points must be wagered on any particular event by distinguished users before a consensus (36) can be calculated.

In another embodiment both a minimum total number of distinguished users (35) must make a prediction and a minimum total number of points must be wagered on any particular event by said distinguished users (35) before a consensus (36) can be calculated.

In another embodiment there is no prerequisite to calculating a consensus (36).

In another embodiment a number is generated that corresponds to degree of agreement between distinguished users (35) for each specific event where a sufficient consensus (36) was reached.

Every prediction by a user of the system serves the dual purpose of continuing to stratify the users by their predictive power (according to the stratification process described above) (Shown in FIG. 2 and referred to in (32)) and also potentially serving as the catalyst for the system to make a prediction by potentially being the expert prediction that cements the consensus (36) of distinguished user (35) picks for a specific outcome.

### EXAMPLE

User Jane Doe has been using the system to make predictions, including predicting the outcomes of hockey games. She risks 50 points against a 110 point possible return that the Carolina Hurricanes will beat the Tampa Bay Lightning (11), (21), (31). When this sporting event occurs, it turns out that Jane's prediction is correct (22), (23). Here is how her correct bet is reflected in her historic performance:

Since this was a prediction of a hockey game, her record of correct hockey game predictions is increased by 1.

Since this was a prediction of a hockey game, her average points per hockey game prediction is adjusted to reflect 1 more prediction and 110 more points.

Since this was a moneyline prediction of a hockey game, her record of correct moneyline hockey predictions is increased by 1.

Since this was a prediction of a hockey game, her average points per moneyline hockey game prediction is adjusted to reflect 1 more prediction and 110 more points.

This process of adjustment is then repeated for the NHL league, the NHL Eastern Conference, the NHL Southeast Division, the Carolina hockey team and the Tampa Hockey team yielding between 12 and 16 adjustments per prediction (12 if teams are from the same conference and division, 14 if they are from the same conference but different divisions, and 16 if they are from the difference conferences).

| | | | | | | | | Moneyline | | | | Spread | |
|---|---|---|---|---|---|---|---|---|---|---|---|---|---|
| | | | | Avg. | Moneyline | Moneyline | Moneyline | Avg. | Spread | Spread | Spread | Avg. | |
| | Correct | Incorrect | Neither | Points | Correct | Incorrect | Tie | Points | Correct | Incorrect | Tie | Points | . . . |
| Hockey | 126 | 119 | 12 | 1.6 | 100 | 51 | 0 | 5.8 | 20 | 48 | 9 | −10.6 | . . . |
| NHL | 126 | 119 | 12 | 1.6 | 100 | 51 | 0 | 5.8 | 20 | 48 | 9 | −10.6 | . . . |
| NHL-East | 65 | 48 | 5 | 4.3 | 41 | 10 | 0 | 12.7 | 10 | 8 | 1 | 2.2 | . . . |
| NHL-West | 61 | 71 | 7 | −2.5 | 59 | 41 | 0 | −9.7 | 10 | 40 | 8 | −28.2 | . . . |
| NHL-East- | 42 | 10 | 1 | 17.6 | 31 | 5 | 0 | 18.3 | 7 | 3 | 1 | 15.3 | . . . |
| South | | | | | | | | | | | | | |
| Atlanta | 3 | 4 | 1 | −23.4 | 2 | 1 | 0 | −1.1 | 1 | 2 | 1 | −10.5 | . . . |
| Carolina | 12 | 1 | 0 | 30.5 | 10 | 0 | 0 | 31.8 | 1 | 1 | 0 | −5.7 | . . . |
| Florida | 5 | 2 | 0 | 0.8 | 3 | 1 | 0 | 1.7 | 1 | 0 | 0 | 30 | . . . |
| Tampa | 18 | 1 | 0 | 40.3 | 14 | 1 | 0 | 32.9 | 2 | 0 | 0 | 40 | . . . |
| Washington | 4 | 2 | 0 | −1.5 | 2 | 2 | 0 | −6.9 | 2 | 0 | 0 | 25.5 | . . . |

Jane Doe's new average points per moneyline prediction of 18.3 per moneyline bet on games involving the NHL's Southeast division now puts her in an distinguished user class (such as the top 1%) compared to all other users. Jane proceeds to make a moneyline prediction of 80 points to win 150 points that Tampa (a team in the Southeast division) will lose to San Jose in tomorrow's game. Her pick is marked by the system as a distinguished user pick (35) since it is a moneyline prediction of a game involving the NHL's Southeast division. It turns out that 10 other distinguished users have made the same prediction and Jane's prediction forms an unanimous prediction of 11 distinguished users (36), this causes the method/system to make the moneyline prediction that indeed San Jose will beat Tampa in tomorrow's game (38).

What is claimed:

1. A method for predicting future outcomes to sporting events, said method comprising:
(a) Accessing a data set comprising the historical outcomes of the community of users wherein every categorized input is associated with the individual user that generated it and the community of users as a whole;
(b) Processing said data set to identify and mark distinguished users;
(c) Processing the future outcomes of marked distinguished users to obtain a consensus for a singular categorized input;
(d) Predicting said consensus as the outcome of a future sporting event.

2. A method of claim 1 wherein said historical outcomes are weighted according to how many points were wagered on each historical outcome.

3. A method of claim 1 wherein both said data sets comprise only the results and predictions of the users registered at the website winthetrophy.com.

4. A method of claim 1 wherein said prediction types are categorized by sporting event, and subcategorized by at least league, or conference, or division, or team, or type of outcome.

5. A method of claim 1 wherein the benchmark for becoming a distinguished user is being ranked in the top 1% of all users in the community of users.

6. A method of claim 1 wherein a supermajority of distinguished users must agree on the outcome of an event for a consensus to be formed.

7. A method of claim 1 wherein a majority of distinguished users must agree on the outcome of an event for a consensus to be formed.

8. A method of claim 1 wherein a plurality of distinguished users must agree on the outcome of an event for a consensus to be formed.

9. A method of claim 1 wherein at least 4 distinguished users must submit a prediction for an event before a consensus can be calculated.

10. A computer or similar apparatus that practices the method of claim 1.

11. A system comprising:
A computer or a network or computers wherein the computer(s)
(a) Accesses a data set comprising the historical outcomes of the community of users wherein every categorized input is associated with the individual user that generated it and the community of users as a whole
(b) Processes said data set to identify and mark distinguished users;
(c) Processes the future outcomes of marked distinguished users to obtain a consensus for a singular categorized input; and
(d) Generates a prediction said consensus as the outcome of a future sporting event.

12. A system of claim 11 wherein said historical outcomes are weighted according to how many points were wagered on each historical outcome.

13. A system of claim 11 wherein both said data sets comprise only the results and predictions of the users registered at the website winthetrophy.com.

14. A system of claim 11 wherein said prediction types are categorized by sporting event, and subcategorized by at least league, or conference, or division, or team, or type of outcome.

15. A system of claim 11 wherein the benchmark for becoming a distinguished user is being ranked in the top 1% of all users in the community of users.

16. A system of claim 11 wherein a supermajority of distinguished users must agree on the outcome of an event for a consensus to be formed.

17. A system of claim 11 wherein a majority of distinguished users must agree on the outcome of an event for a consensus to be formed.

18. A system of claim 11 wherein a plurality of distinguished users must agree on the outcome of an event for a consensus to be formed.

19. A system of claim 11 wherein at least 4 distinguished users must submit a prediction for an event before a consensus can be calculated.
